(19) United States
(12) Patent Application Publication
(10) Pub. No.: US 2011/0280460 A1
(43) Pub. Date: Nov. 17, 2011

(54) IRON QUANTIFICATION OF BRAIN MICROBLEEDS

(75) Inventors: Grant A. McAuley, Loma Linda, CA (US); Matthew Schrag, Loma Linda, CA (US); Wolff M. Kirsch, Redlands, CA (US); Samuel R. Sturgill Barnes, Grand Terrace, CA (US)

(73) Assignee: LOMA LINDA UNIVERSITY, Loma Linda, CA (US)

(21) Appl. No.: 13/107,799

(22) Filed: May 13, 2011

Related U.S. Application Data
(60) Provisional application No. 61/334,522, filed on May 13, 2010.

(51) Int. Cl. G06K 9/00

(52) U.S. Cl. 382/131

(57) ABSTRACT

A method to quantify iron content or effective diameter of a localized iron source in an anatomical region of a subject is provided herein. The first step is to obtain a phase image from a magnetic resonance scan of the anatomical region of the subject. The next step is identifying a dipole pattern in the phase image corresponding to a localized iron source in the anatomical region. One or more than one image parameter of the dipole pattern is then measured and related to the iron content of the localized iron source.

### CROSS-REFERENCE TO RELATED APPLICATIONS

The present application claims the benefit of U.S. Provisional Patent Application 61/334,522, titled “Iron Quantification of Microbleeds in Postmortem Brain,” filed May 13, 2010, the contents of which are incorporated by reference herein in its entirety.

### BACKGROUND

Brain microbleeds (BMB) are associated with ischemic and hemorrhagic stroke, cerebral amyloid angiopathy (CAA), neurotrauma, Alzheimer's disease (AD), vascular dementia, cognitive decline, hypertension and aging. The presence of BMB in ischemic stroke, intracerebral hemorrhage (ICH) and CAA is associated with future hemorrhage. Whether presence of BMB increases the risk of bleeding when thrombolytic and antithrombotic agents are used is an important and controversial question. Thus, BMB are associated with both chronic and acute illness of no small consequence in our aging population.

BMB are visible in gradient recalled echo (GRE) T₂* magnetic resonance (MR) imaging as focal regions of signal loss and have been histopathologically related to hemosiderin, the (paramagnetic) iron-protein complex associated with pathologic iron storage following hemorrhage and ferritin breakdown. Thus, BMB represent a source of pathologic iron in the brain that is potentially cytotoxic (e.g., by free radical production through the Fenton reaction). Oxidative damage, iron accumulation and/or changes in iron metabolism have been implicated in neurodegenerative and cerebrovascular diseases. In addition, since iron is deposited at the site of a BMB in proportion to the amount of extravasated blood, iron content in BMB can be considered a marker for the severity of underlying vessel disease. Therefore the quantified iron content in BMB is potentially informative regarding disease progression and the efficacy of treatment.

Past efforts to quantify brain iron have focused on content estimation within distributed brain regions. BMB however represent a localized source of iron deposition. Iron content and concentration of BMB have been heretofore absent in the literature. In addition, conventional “magnitude” MR images have significant limitations especially for localized iron quantification, and the well known blooming effect typically obscures the true dimensions of an iron susceptibility source. A few studies have compared radiologic BMB to postmortem human tissue and have noted evidence of associated tissue damage. However, in vivo methods would allow the investigation of temporal relationships regarding tissue damage evolution following BMB and possible interventions. In particular, methods correlating BMB iron content levels with the severity and evolution of tissue damage can shed light on the role of iron in the disease process.

Therefore, there is the need for an improved method of quantifying iron in BMB, which is capable of determining iron content and/or concentration, that is not associated with disadvantages, like the blooming effect, of conventional “magnitude” MR images.

### SUMMARY

According to one embodiment of the invention, there is provided a method to quantify localized iron sources using MR phase images. This method can be used to quantify iron content and estimate true source diameter, unobscured by the blooming effect, in actual BMB.

According to one embodiment of the invention, there is provided a method to quantify iron content or effective diameter of a localized iron source in an anatomical region of a subject, comprising the steps of (a) obtaining a phase image from a magnetic resonance scan of the anatomical region of the subject; (b) identifying a dipole pattern in the phase image corresponding to a localized iron source in the anatomical region; (c) measuring one or more than one image parameter of the dipole pattern; and (d) relating the image parameter measured in step (c) to a quantity of the iron contained in the localized iron source or the effective diameter of the source.

In a preferred embodiment of the invention, the phase image is obtained from an in vivo magnetic resonance scan.

In alternative versions of the method, the phase image is a raw phase image, a high-pass filtered phase image or phase-enhanced magnitude image.

In a particularly preferred embodiment of the method, the anatomical region comprises a portion of a brain and the localized iron source corresponds to a brain microbleed.

According to one embodiment of the invention, the subject is a mammal, preferably a human.

In alternative versions of the method, the dipole pattern is in a horizontal, coronal or axial orientation.

According to one embodiment of the invention, the dipole pattern is identified using one or more than one matching template.

In one embodiment, the image parameters r_{π} and r′_{π} are determined from a rectangle bounding the dipole pattern, the rectangle comprising a width and a height, where r_{π} is one half of the width and r′_{π} is one half of the height of the bounding rectangle.

Another embodiment of the present invention further comprises converting gray-scale high pass filtered phase images to binary images before drawing bounding rectangles.

In alternative versions of the method, the image parameter is related to the mass of iron, the iron concentration or the diameter of the localized iron source.

Another embodiment of the present invention further comprises categorizing disease severity based on the quantity of iron determined in step (d).

One embodiment of the present invention provides a method that further comprises repeating steps (a), (b), (c) and (d) at a later time point to monitor any change in disease severity.

The invention is described in more detail by the following description.

### BRIEF DESCRIPTION OF THE DRAWINGS

These and other features, aspects and advantages of the present invention will become better understood with regard to the following description, appended claims, and accompanying figures where:

FIG. 1A shows a bounding rectangle drawn around a schematic of a spherical dipole pattern in horizontal orientation, where the main field B₀ is parallel to the axis of the dipole, the black lines represent the phase wraps (shown are π and 3π wraps), and the widths and heights of the rectangle are respectively 2r_{π} and 2r′_{π};

FIG. 1B shows a bounding rectangle drawn around the dipole in axial orientation showing π and 3π phase wraps, where the plane shown is a cross section of the equatorial plane of FIG. 1A, thus the dimensions are equal to 2r_{π}, and the main field is shown projecting out of the plane of the page;

FIG. 1C shows phase profiles drawn along the dipole equator (dotted lines in FIGS. 1A and 1B);

FIG. 1D is a magnified view of the wrapped profile in FIG. 1C superimposed with a circle representing a spherical iron source;

FIG. 2A is an MR image showing tissue slices of postmortem brain embedded in agarose and scanned at high field MRI, where an arrow points to a cortical brain microbleed (BMB);

FIG. 2B shows a T1 weighted image of the tissue slices of postmortem brain shown in FIG. 2A that reveals the presence of the BMB;

FIG. 2C is a close-up view of the tissue BMB shown in FIG. 2A (top of panel) and the corresponding MR image shown in FIG. 2B (bottom of panel);

FIG. 2D is an MR image showing small pieces of tissue containing BMB (arrow) or free of BMB (cut from dotted region) that were dissected and assayed for iron content using atomic absorption spectroscopy;

FIG. 3A shows magnitude images of two cortical grey BMB in postmortem CAA brain in horizontal orientations, exhibiting characteristic dipole patterns;

FIG. 3B shows raw phase images of two cortical grey BMB in postmortem CAA brain in horizontal orientations, exhibiting characteristic dipole patterns;

FIG. 3C shows high-pass filtered phase images of two cortical grey BMB in postmortem CAA brain in horizontal orientations, exhibiting characteristic dipole patterns, where the top lesion (dotted rectangle) is shown in the axial images (FIGS. 3E-3H);

FIG. 3D shows phase-enhanced magnitude images of two cortical grey BMB in postmortem CAA brain in horizontal orientations, exhibiting characteristic dipole patterns;

FIG. 3E shows a magnitude image of a cortical grey BMB (the top lesion in FIG. 3C) in postmortem CAA brain in axial orientation;

FIG. 3F shows a raw phase image of a cortical grey BMB (the top lesion in FIG. 3C) in postmortem CAA brain in axial orientation;

FIG. 3G shows a high-pass filtered phase of SWI image of a cortical grey BMB (the top lesion in FIG. 3C) in postmortem CAA brain in axial orientation;

FIG. 3H shows a phase-enhanced magnitude SWI image of a cortical grey BMB (the top lesion in FIG. 3C) in postmortem CAA brain in axial orientation;

FIG. 3I shows a bounding rectangles surrounding a magnification (12×) of the top lesion in the panel of FIG. 3C (dotted rectangle) in horizontal orientation;

FIG. 3J shows a bounding rectangle surrounding a magnification (12×) of the top lesion in the panel of FIG. 3C (dotted rectangle) in axial orientation (FIG. 3J is a magnification of the panel shown in FIG. 3G);

FIG. 3K is a magnification of the lower (unmarked) lesion in the panel shown in FIG. 3C showing the π phase wrap and an interior hyperintense ring of radius≦r_{3π} (respectively, highlighted by dotted lines);

FIG. 3L is the same image as FIG. 3K showing a bounding rectangle used to estimate the diameter of the inner ring (dotted lines);

FIG. 4 is a graph showing BMB Iron Content vs. Image Parameters;

FIG. 5 is a graph showing estimated BMB lesion diameters;

FIG. 6 is a scatter plot showing estimated BMB iron concentrations for 13 samples;

FIG. 7A shows two successive coronal sections of a rat brain with a collagenase-induced bleed in the right caudate/putamen (CP);

FIG. 7B shows dissected tissue surrounding the bleed taken from the right CP and a control tissue sample taken from the left CP;

FIG. 8A is a phase enhanced magnitude image of in vivo rat brain showing a well formed dipole;

FIG. 8B is a HP image of the dipole shown in FIG. 8A, where the dipole phase wraps are well defined and a bounding rectangle (defined in the binary image of FIG. 8C) is shown superimposed on the HP image;

FIG. 8C is binary conversion of FIG. 8B showing distinct black/white phase wraps delineated by a bounding rectangle;

FIG. 8D shows a phase enhanced magnitude image of a less distinct dipole;

FIG. 8E is an HP image of the dipole shown in FIG. 8D, where the bottom vertical phase wrap is indistinct and a bounding rectangle (defined in the binary image of FIG. 8F) is shown superimposed on the HP image

FIG. 8F is binary conversion of FIG. 8E showing distinct black/white phase wraps delineated by a bounding rectangle;

FIG. 9A shows a magnitude SWI image in coronal orientation of a BMB induced in the caudate/putamen of the living rat brain;

FIG. 9B shows a raw phase SWI image in coronal orientation of a BMB induced in the caudate/putamen of the living rat brain;

FIG. 9C shows a high pass-filtered SWI image in coronal orientation of a BMB induced in the caudate/putamen of the living rat brain;

FIG. 9D shows a phase-enhanced magnitude SWI image in coronal orientation of a BMB induced in the caudate/putamen of the living rat brain;

FIG. 9E shows a magnification of the dipole pattern in FIG. 9C;

FIG. 9F shows magnitude SWI images in axial orientation of a BMB induced in the caudate/putamen of the living rat brain (two successive slices are shown);

FIG. 9G shows raw phase SWI images in axial orientation of a BMB induced in the caudate/putamen of the living rat brain (two successive slices are shown);

FIG. 9H shows high pass-filtered SWI images axial orientation of a BMB induced in the caudate/putamen of the living rat brain (two successive slices are shown);

FIG. 9I shows phase-enhanced magnitude SWI images in axial orientation of a BMB induced in the caudate/putamen of the living rat brain (two successive slices are shown); and

FIG. 10 is a graph showing the cube root of iron mass from collagenase-induced BMB plotted against r′_{π}.

### DETAILED DESCRIPTION

According to one embodiment of the invention, there is provided a method to quantify iron content of a localized iron source in an anatomical region of a subject. The method comprises the steps of (a) obtaining a phase image from a magnetic resonance scan of the anatomical region of the subject; (b) identifying a dipole pattern in the phase image corresponding to a localized iron source in the anatomical region; (c) measuring one or more than one image parameter of the dipole pattern; and (d) relating the image parameter measured in step (c) to a quantity of the iron contained in the localized iron source.

The method will now be disclosed in detail in the following examples, which validate this approach for use in quantifying the iron content in brain microbleeds.

LIST OF SYMBOLS

| | |
|---|---|
| r′_{π} | point where the phase reaches the value of π along vertical dipole axis |
| U | Collagenase enzyme activity units |
| Δ_{χ} | change in magnetic susceptibility |
| ρ | density |
| m | mass |
| m_{Fe} | mass of iron |
| f_{(Fe)} | w/w iron concentration |
| POD | Postoperative day |

### Theoretical Background and Rationale

MR voxels containing and surrounding paramagnetic (or ferromagnetic) brain iron deposits have an altered local field ΔB, and thus an altered magnetization phase with respect to their neighbors. This phase difference is detectable in GRE pulse sequences and described by the formula (for a right handed system):

Δφ=−γΔBT_{E} [1]

where Δφ is the change in phase, γ is the proton gyromagnetic ratio, and TE is the echo time. Thus, the amount of iron in a voxel can potentially be related to the phase.

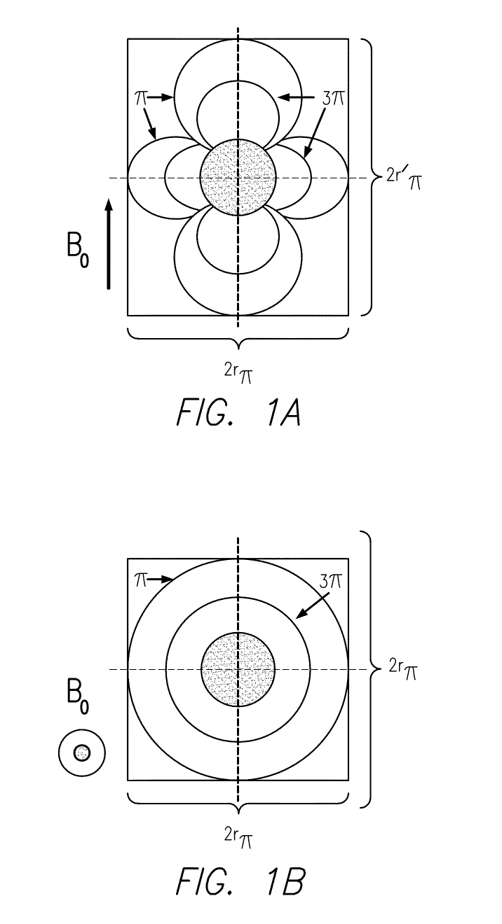

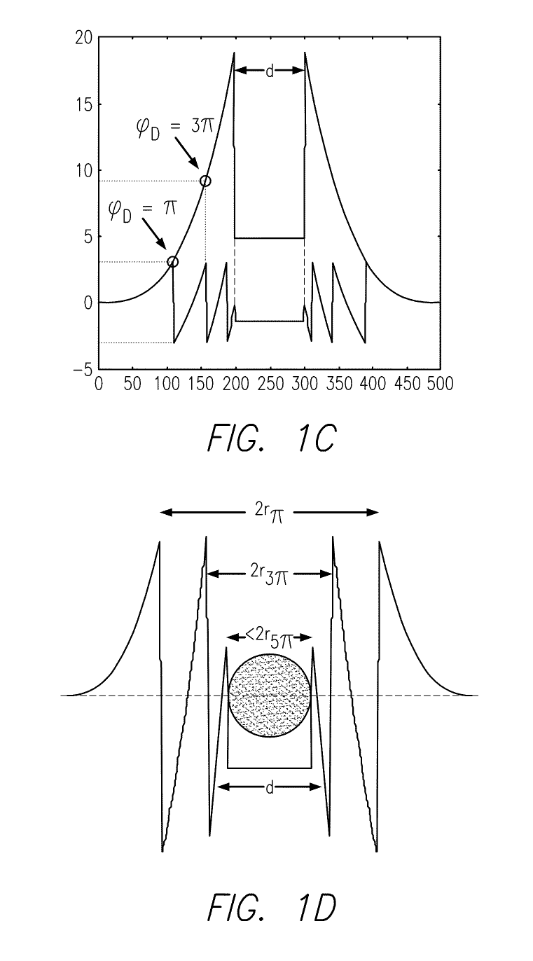

An easily identified parameter in modulo 2π phase-wrapped images can be mathematically related to iron mass in a localized spherical sample (Eq. 2). Briefly, FIG. 1A shows a schematic cross section of an iron sample dipole phase pattern induced by the main MRI magnetic field (B₀), and FIG. 1C shows a corresponding phase profile taken across the horizontal dotted line in FIG. 1A. The value on the abscissa corresponding to Δφ_{D}=π is denoted by r_{π}, and r_{π} is easily measured from the wrapped profile (FIG. 1D) or the rectangle bounding the π-phase wrap of the dipole pattern (FIG. 1A). Under the assumptions that i) the magnetic susceptibility is constant both internal (χᵢ) and external (χₑ) to the iron sample, ii) Δχ, the susceptibility difference, defined as Δχ≡(χᵢ−χₑ), is very small (˜10⁻⁵), iii) the density of the samples ρ is constant, and iv) all background phase has been removed, r_{π} is related to iron mass of the sample by Eq. 2:

$${m}_{Fe} = ( \frac{4 {π}^{2} ρ}{γ Δ χ {B}_{0} {T}_{E}} ) {r}_{π}^{3} \qquad [ 2 ]$$

The true radius a of the iron source (unobscured by the blooming effect) can also be related to r_{π} by Eq. 3, and for a given Δχ, r_{π} can in principle be converted among magnet field strength and echo time by Eq. 4:

$$\begin{matrix}a = {( \frac{3 π}{γ Δ χ {B}_{0} {T}_{E}} )}^{1 / 3} {r}_{π} & [ 3 ] \\ \frac{{r}_{{π}_{2}}}{{{r}_{π}}_{1}} = {( \frac{{B}_{{0}_{2}} {T}_{{E}_{2}}}{{B}_{{0}_{1}} {T}_{{E}_{1}}} )}^{1 / 3} & [ 4 ]\end{matrix}$$

In this present study, we denote by r′_{π} the value on the ordinate dipole axis corresponding to Δφ_{D}=π. Thus, r′_{π} is analogously related to the vertical π-wrap and phase profile (taken along vertical dotted line in FIG. 1A) as r_{π} is to the horizontal. It follows that the profile intensities are proportional to each other (proportionality constant of −2), and that r_{π} and r′_{π} are related by Eq. 5 below. Thus, r′_{π} analogs of Eqs. 2-4 can be expressed as Eqs. 6-8:

$$\begin{matrix}{r}_{π}^{′} = {2}^{1 / 3} {r}_{π} & [ 5 ] \\ {m}_{Fe} = ( \frac{2 {π}^{2} ρ}{γ Δ χ {B}_{0} {T}_{E}} ) {r}_{π}^{′3} & [ 6 ] \\ a = {( \frac{3 π}{2 γ Δ χ {B}_{0} {T}_{E}} )}^{1 / 3} {r}_{π}^{′} & [ 7 ] \\ \frac{{r}_{{π}_{2}}^{′}}{{r}_{{π}_{1}}^{′}} = {( \frac{{B}_{{0}_{2}} {T}_{{E}_{2}}}{{B}_{{0}_{1}} {T}_{{E}_{1}}} )}^{1 / 3} & [ 8 ]\end{matrix}$$

Both r_{π} and r′_{π} can simultaneously be measured from the dimensions of the rectangle bounding the dipole phase pattern as shown in FIG. 1A. Because r′_{π} is larger than r_{π} (Eq. 5) it has the advantage of a larger dynamic range compared with r_{π}.

FIG. 1B shows an axial cross section of the phase-wrapped dipole pattern corresponding to the equatorial plane of FIG. 1A. The prominent curved lines in FIGS. 1A and 1B correspond to phase wraps (π and 3π wraps are shown) which appear as concentric circles in the axial orientation for a spherical source. Thus, r_{π} can alternately be determined from axial bounding rectangles (FIG. 1B), and the horizontal profile (along the horizontal dashed line of FIG. 1A and shown in FIGS. 1C and 1D) is equivalent to an axial profile along any diameter (e.g., along the horizontal dashed line of FIG. 1B). Careful examination of the profiles reveal that ideally, phase wraps can be used to determine the diameter of a susceptibility source (FIGS. 1C and 1D). In addition, while Eqs. 3 and 7 require a knowledge of Δχ to relate source diameter to r_{π} and r′_{π}, in principle diameter can be determined by phase wrap geometry alone. In practice, signal loss in noisy dipole centers will obscure higher order phase wraps. Nevertheless, the sequence of phase diameters 2r_{π}, 2r_{3π}, 2r_{5π}, etc. that are discernable provide increasingly better approximations of the true diameter, and allows classification of sources based on diameter thresholds unobscured by blooming. It follows from equation 4 that r_{nπ}=n^{(-1/3)}r_{π}. This implies that higher order phase diameters need not be measured directly. If a higher order phase wrap is present, the corresponding phase diameter can be calculated based on the most robust wrapping diameters, r_{π} or r′_{π}.

Eqs. 2 and 6 predict proportional relationships between the r_{π} and r′_{π} parameters and sample iron mass. Therefore, plots of these experimentally measured variables were used to verify the predictions and validate the method. Assuming similar values of iron sample density and susceptibility, such plots can then be used as standard curves to predict iron content in similar samples. In addition, we use phase diameters to estimate BMB source diameter and iron concentration.

FIGS. 1A-1D are schematics and drawings of an Image Parameter Measurement that shows phase image parameters can be measured using bounding rectangles or phase profiles. FIG. 1A shows a bounding rectangle drawn around schematic of a spherical dipole pattern in horizontal orientation. The widths and heights of the rectangle (solid lines) are respectively 2r_{π} and 2r′_{π}. The curved lines represent the phase wraps (shown are π and 3π wraps). The main field B₀ is parallel to the axis of the dipole. FIG. 1B shows a bounding rectangle drawn around the dipole in axial orientation showing π and 3π phase wraps. The plane shown is a cross section of the equatorial plane of FIG. 1A, thus the dimensions are equal to 2r_{π}. The main field is shown projecting out of the plane of the page. FIG. 1C shows phase profiles drawn along the dipole equator (dotted lines in FIGS. 1A and 1B) appear modulo 2π (lower trace). These wrapped profiles can be used to measure r_{π}, or can in principle be unwrapped (upper trace) and used to estimate, d, the diameter of the iron source or an arbitrary phase value (e.g., 3π). The unwrapped profile intersects the wrapped profile where the phase Δφ_{D} is equal to π. The parameter r′_{π} can be related to the phase profile taken along the vertical black dotted line in FIG. 1A. FIG. 1D is a magnified view of the wrapped profile in FIG. 1C superimposed with a circle representing a spherical iron source. Peak to peak widths of phase wrappings are proportional to r_{π} and r_{3π}. Note that the distance between the most medial peaks is equal the diameter of the source (d). However, since these peaks do not represent a full phase wrapping d<2r_{5π}, and r_{3π}<d<r_{5π}.

To test magnetic resonance phase image methods to quantify iron content and source diameter of brain microbleeds (BMB) in postmortem human tissue. Tissue slices containing BMB were imaged using a susceptibility weighted imaging protocol at 11.7T. Image features and parameters in high-pass filtered phase images were related to lesion iron content and source diameter by using a mathematical model. BMB lesions were dissected from tissue slices and assayed for iron using atomic absorption spectrometry. BMB iron content was plotted against phase image parameters to compare experimental data with underlying theory. Image features and model equations were used to estimate BMB diameter and iron concentration. A strong linear relationship predicted by theory was observed in the experimental data, validating our methods, and presenting a tentative standardization curve where BMB iron in similar tissues could be related to image parameters.

### Postmortem Human BMB Sample Preparation

Post mortem human brain tissue was donated from the Alzheimer's Disease Research Center Brain Bank at the University of California, Los Angeles. The research protocol was approved by the Institutional Review Board of Loma Linda University Medical Center. On average five 1 cm coronal slices representing frontal, temporal/parietal and occipital lobar areas were obtained from three cases histopathologically diagnosed as comorbid for advanced AD (Braak and Braak V-VI) and CAA (Vonsattel stage 3). The tissue slabs were embedded in 2% agarose and imaged on a Siemens' 3T MRI clinical scanner using a standard SWI protocol (referred to in text as preparation images). After imaging, the tissue was separated from the agarose and magnitude and phase preparation images were used to identify and dissect microbleeds. Approximately 40 blocks of tissue were collected, each containing at least one BMB. Care was taken to represent each autopsy case and each brain region. To alleviate air-tissue interface susceptibility artifacts encountered in ex vivo imaging of brain tissue, tissue blocks were again embedded in 2% degassed agarose in plastic scintillation tubes. Care was taken to eliminate small air bubbles which produce artifacts that can mimic the presence of BMB iron.

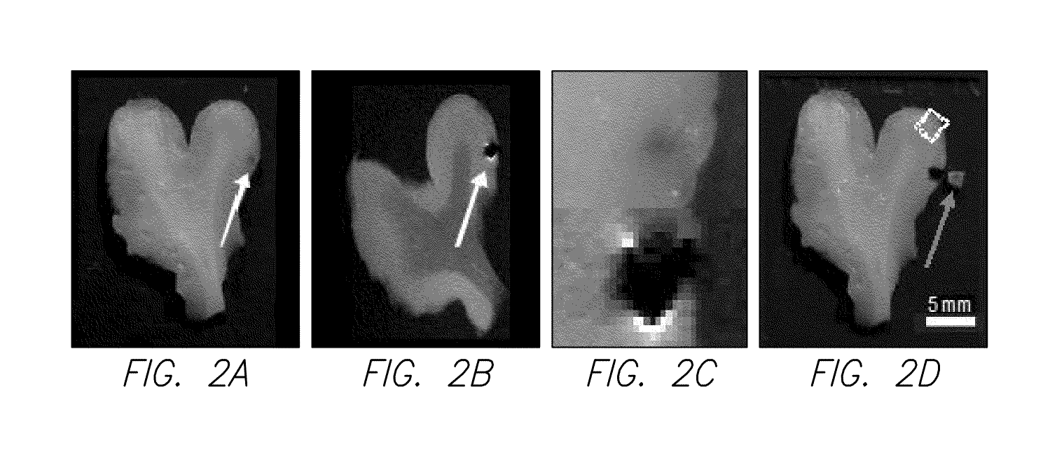

FIGS. 2A-2D are MR images of BMB in Postmortem Brain. FIG. 2A is an MR image showing tissue slices were embedded in agarose and scanned at high field MRI. Arrows point to a cortical BMB and FIG. 2B shows a T1 weighted image that reveals the presence of the BMB (11.7T, TR/TE: 630.8/17.9, NEX: 4, FOV: 22 mm, MAT: 256×256, Thk: 0.3 mm). FIG. 2C is a close-up view of the tissue BMB (top of panel) and the corresponding MR image correlate (bottom of panel). FIG. 2D is an MR image showing small pieces of tissue containing BMB (arrow) or free of BMB (cut from dotted region) that were dissected and assayed for iron content using atomic absorption spectroscopy.

### Magnetic Resonance Imaging

Susceptibility weighted imaging (SWI) is a GRE sequence that uses magnetic susceptibility-dependent complex phase information to provide or enhance image contrast and is very sensitive in BMB detection. Besides the preparation image sequence used in sample preparation (see above), we used two SWI sequences for this study (referred to in text as data images): a 3D SWI horizontal sequence, and a 2D axial sequence. The 2D sequence was used because comparative 3D axial scans had significant background phase apparently due to inadequate magnetic shimming.

Sample tubes were scanned in an 11.7T small vertical-bore MR scanner (Bruker Biospin, Billerica Mass.) using the following parameters: 1): 3D horizontal sequence: TR/TE: 100/7 ms, flip angle: 20°, matrix: 256×256, NEX: 1, FOV: 2.2 cm, in-plane resolution: 0.0859 mm×0.0859 mm, and 32 slices of thickness 0.688 mm. 2) a 2D SWI axial sequence: TR/TE: 154.4-617/7 ms, flip angle: 20°, matrix: 256×256, NEX: 4, FOV: 2.2 cm, in-plane resolution: 0.0859 mm×0.0859 mm, slices: 20-40 of thickness 0.688 mm.

### Image and Data Processing

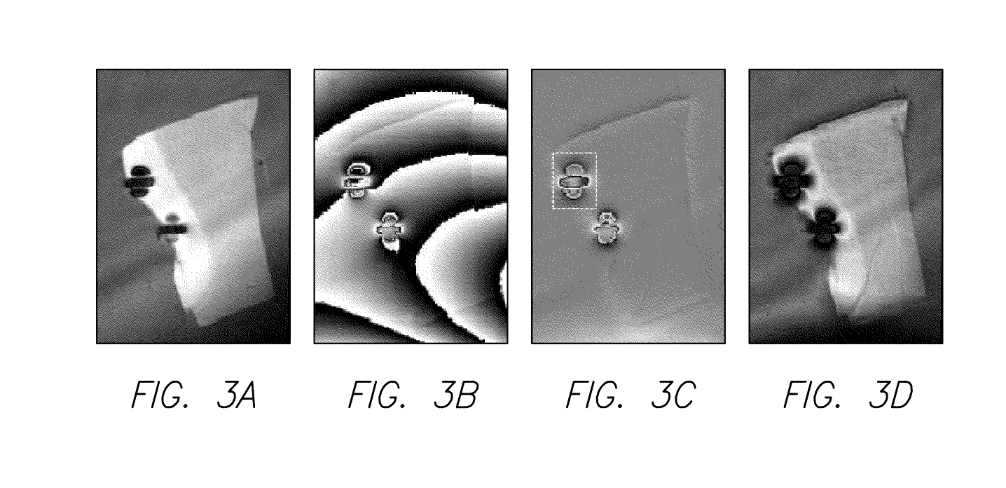

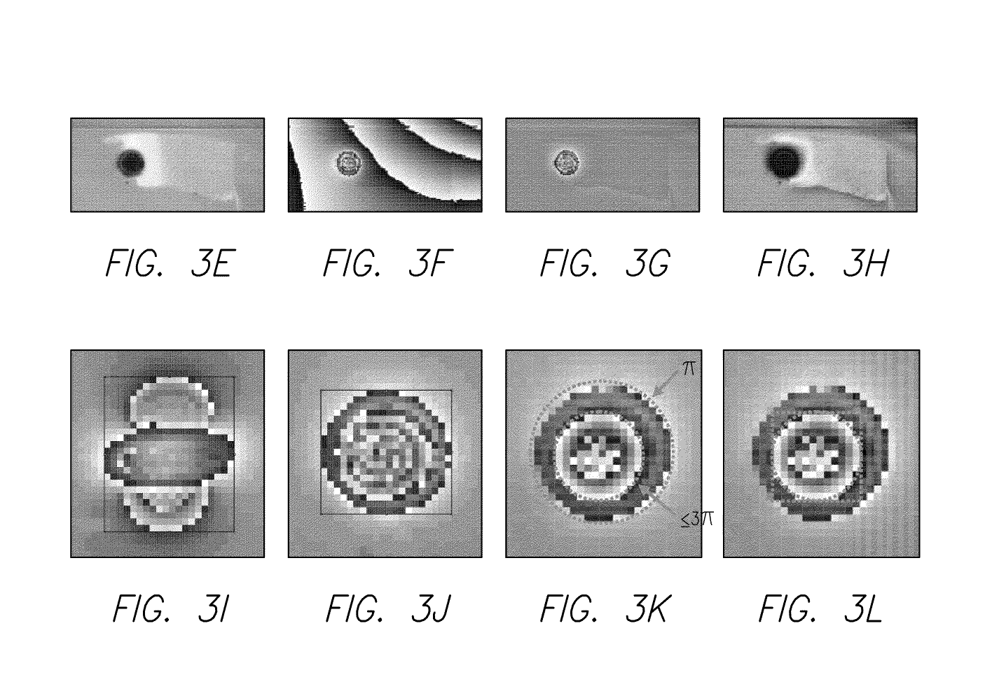

Raw horizontal and axial phase images were respectively high-pass filtered with 16×32 and 32×32 frequency domain filters, respectively using SPIN software (MRI Institute, Detroit, Mich.). Magnitude images were multiplied four times by a phase mask created from the high-pass filtered (HP) images to produce phase-enhanced magnitude images. The image parameters r_{π} and r′_{π} were obtained from the horizontal HP images using the height and width of the rectangle bounding the dipole phase patterns of each sample. In addition, the ratio of the sides of rectangles bounding dipole patterns in the axial images were used to help assess the spherical symmetry of the samples. Bounding rectangles are shown in the schematics of FIGS. 1A and 1B, and for real data samples in FIGS. 3I and 3J. Using the ImageJ software package (ImageJ, NIH), the rectangle was drawn, its height and width were determined, and r_{π}(r′_{π}) is calculated as ½ of width (height) of the rectangle.

### Iron Content Determination

Tissue slices were removed from agarose and BMB were located in the slices with the aid of SWI data images. Small blocks of tissue surrounding the BMB were dissected from the slices using a diamond knife (FIG. 2). To increase the fraction of BMB iron versus background iron, the surrounding tissue in each block was trimmed away as deemed necessary or practical. Control blocks were also dissected and care was taken so that control blocks were cut out of similar tissue (e.g., cortical grey matter) as BMB blocks. All sample blocks were weighed with a precision mass balance. Samples were wet ashed: blocks (2-21 mg) were dissolved in 250 μl of 70% HNO₃ for 12 to 48 hours, heated at 80° C. for 20 min, and allowed to cool to room temperature. 250 μl of 10M of H₂O₂ were added, and after 30 min, samples we heated samples at 70° C. for 15 min and allowed to cool. Iron concentrations were measured in triplicate by graphite furnace atomic absorption spectrometry (SpectrAA 220Z, Varian, Victoria, Australia).

### BMB Diameter and Iron Concentration Calculation

Bounding rectangles were drawn around the innermost hyperintense ring in axial dipole patterns from 13 samples (FIG. 3K). The innermost ring corresponded to the r_{3π} or r_{5π} phase wrap in the samples. In cases of uncertainty ( 5/13) the lower wrap was used (i.e., r_{3π} instead of r_{5π}). The average of the dimensions of the rectangle was taken as the diameter of the lesion. Though the average ratio of the rectangle dimensions was 0.96±0.03 (mean±standard error), the dimensions typically differed by a few pixels (0 pixels-4 samples; 1 pixel-5 samples; 2 pixels-3 samples; 3 pixels-1 sample), and rectangles were easier to objectively place around the rings than circles. The phase diameters 2r_{3π}, 2r_{5π}, and 2r_{7π} were calculated using the corresponding r_{π} for each sample according to the formulas: r_{nπ}=n^{-1/3}r_{π} for n=3, 5, and 7. Sample iron mass (as determined above) was divided by (π/6) d³ to obtain iron concentrations. Units of μg/cm³ were converted to μg/g wet tissue weight assuming a tissue density equal to water.

### Sample Inclusion/Exclusion

Over 40 putative BMB were originally identified in 40 MR scans. For practical reasons, a subset of 26 of the most promising putative BMB were chosen and afterward underwent image and tissue processing. Selection was based primarily on the quality of the dipole appearance (e.g., symmetry, distinct edges) seen in magnitude SWI scans. Seven samples were excluded after image and tissue processing: one sample was damaged during dissection, two samples displayed inadequate background phase removal, one sample dipole was due to an air bubble, one sample dipole was highly distorted, and two samples displayed faint and indistinct dipoles. A total of 19 samples were included in the iron content analysis. Six additional samples were excluded from iron concentration analysis and 13 samples were used.

### Statistical Analysis

The predicted proportional relationships between BMB iron mass and the image parameters r_{π} and r′_{π} was tested by linear regression analysis using SigmaPlot version 11 (Systat Software, Inc., Chicago, Ill.). Plots of these variables were constructed along with a best-fit least squares regression lines. Normality of BMB iron concentration was tested using a Shapiro-Wilk test. Statistical significance was considered at p≦0.05.

### Results

Magnitude, raw phase, high-pass filtered phase and phase-enhanced magnitude horizontal and axial images of two BMB samples are shown in FIG. 3. Robust characteristic dipole patterns are seen in each image. High-pass filtered images generally exhibited dipole patterns with clearly visible phase wraps surrounded by a largely homogenous background and phase profiles with sharp peaks (FIGS. 3I-3K). The average r′_{π} to r_{π} was 1.24±0.13 consistent with the theoretical value of 2^{1/3}=1.26. This implies that the filtering did not significantly distort the aspect ratio of the dipole pattern.

FIGS. 3A-3L are SWI of BMB in Postmortem CAA Brain, namely, magnitude (FIGS. 3A and 3E), raw phase (FIGS. 3B and 3F), high-pass filtered phase (FIGS. 3C and 3G) and phase-enhanced magnitude (FIGS. 3D and 3H) images of two cortical grey BMB, showing horizontal (FIGS. 3A-3D) and axial (FIGS. 3E-3H) orientations respectively. The top lesion (dotted rectangle) in the panel of FIG. 3C is shown in the axial images (FIGS. 3E-3H). Characteristic dipole patterns were seen in each image. In FIGS. 3I and 3J bounding rectangles are shown surrounding magnifications (12×) of the top lesion in the panel of FIG. 3C (dotted rectangle) in horizontal (FIG. 3I) and axial (FIG. 3J) orientations (FIG. 3J is a magnification of the panel shown in FIG. 3G). FIG. 3K is a magnification of the lower (unmarked) lesion in the panel shown in FIG. 3C showing the it phase wrap and an interior hyperintense ring of radius≦r_{3π} (respectively highlighted by red dotted lines). FIG. 3L is the same image as FIG. 3K showing a bounding rectangle used to estimate the diameter of the inner ring (dotted lines). The lesion diameter is estimated by this diameter, and bounded by the phase diameters 2r_{π} and 2r_{3π} (see text).

Measured iron mass, r′_{π}, r_{π}, as well as estimated diameter and iron concentration is shown for BMB samples in Table 1.

TABLE 1
Data from postmortem BMB.

| Sample | m_{Fe} (μg) | r′_{π} (mm) | r_{π} (mm) | d (mm) | [Fe] (μg/g) |
|---|---|---|---|---|---|
| 1 | 0.73 ± 0.05 | 0.86 ± 0.14 | 0.65 ± 0.09 | — | — |
| 2 | 0.98 ± 0.02 | 0.99 ± 0.13 | 0.77 ± 0.09 | 1.031 | 1705 |
| 3 | 1.54 ± 0.03 | 1.03 ± 0.13 | 0.86 ± 0.09 | 1.203 | 1687 |
| 4 | 0.90 ± 0.02 | 0.86 ± 0.14 | 0.73 ± 0.09 | 0.988 | 1786 |
| 5 | 0.86 ± 0.04 | 0.95 ± 0.13 | 0.65 ± 0.09 | 0.859 | 2580 |
| 6 | 1.04 ± 0.03 | 1.20 ± 0.12 | 0.86 ± 0.09 | 1.160 | 1269 |
| 7 | 2.01 ± 0.09 | 1.29 ± 0.12 | 0.99 ± 0.09 | 1.031 | 3502 |
| 8 | 1.14 ± 0.07 | 1.07 ± 0.13 | 0.73 ± 0.09 | — | — |
| 9 | 0.43 ± 0.06 | 0.86 ± 0.14 | 0.60 ± 0.09 | 0.816 | 1499 |
| 10 | 0.55 ± 0.03 | 0.77 ± 0.14 | 0.60 ± 0.09 | 0.859 | 1656 |
| 11 | 0.75 ± 0.03 | 1.03 ± 0.13 | 0.90 ± 0.09 | 0.988 | 1473 |
| 12 | 8.15 ± 0.16 | 1.81 ± 0.12 | 1.50 ± 0.09 | — | — |
| 13 | 0.49 ± 0.03 | 0.86 ± 0.14 | 0.77 ± 0.09 | 1.160 | 595 |
| 14 | 13.1 ± 0.3 | 2.19 ± 0.11 | 2.02 ± 0.09 | — | — |
| 15 | 0.065 ± 0.007 | 0.52 ± 0.18 | 0.43 ± 0.27 | — | — |
| 16 | 1.02 ± 0.04 | 0.90 ± 0.14 | 0.86 ± 0.09 | 1.117 | 1400 |
| 17 | 2.50 ± 0.05 | 1.33 ± 0.12 | 1.12 ± 0.09 | 1.246 | 2464 |
| 18 | 3.79 ± 0.14 | 1.50 ± 0.12 | 1.42 ± 0.09 | 1.461 | 2322 |
| 19 | 1.39 ± 0.10 | 1.16 ± 0.13 | 0.90 ± 0.09 | — | — |

Iron mass is measured by atomic absorption spectrometry.
r′_{π} and r_{π} are measured by bounding rectangles in horizontal filtered phase images.
Diameter and concentration estimates are determined as described in the text.

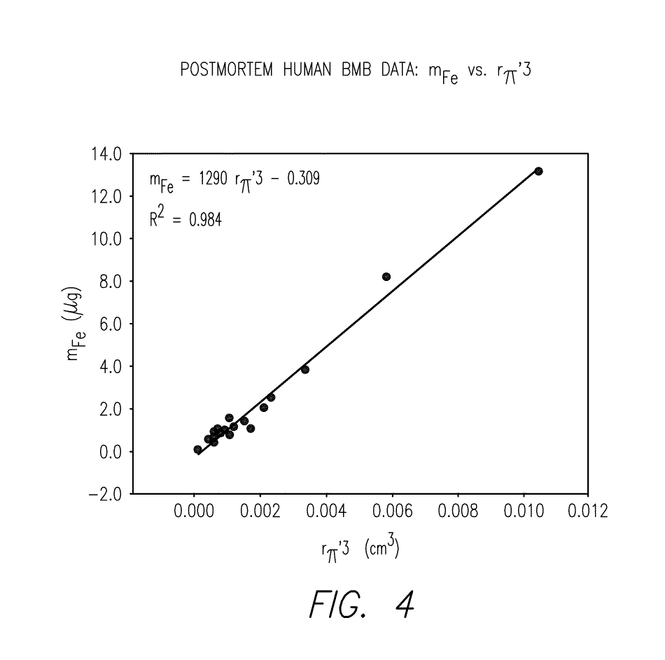

BMB iron mass vs. r′_{π}³ is plotted in FIG. 4, and exhibits a strong linear relationship (R²=0.984, p<0.001) between variables with a slope of 1260 μg/cm³ (p<0.001). The y-intercept of the plot is small but statistically significant (−0.309 μg, p=0.021). This value is smaller than all the iron masses of the samples except one (Sample 15 in Table 1), and can be interpreted as an indicator of the sensitivity of the technique. The strong linear relationship is predicted by Eq. 6 and thus confirms the usefulness of our quantification method to measure iron content in BMB from human tissues. BMB iron content ranged from 0.065 to 13.1 μg (median 1.0).

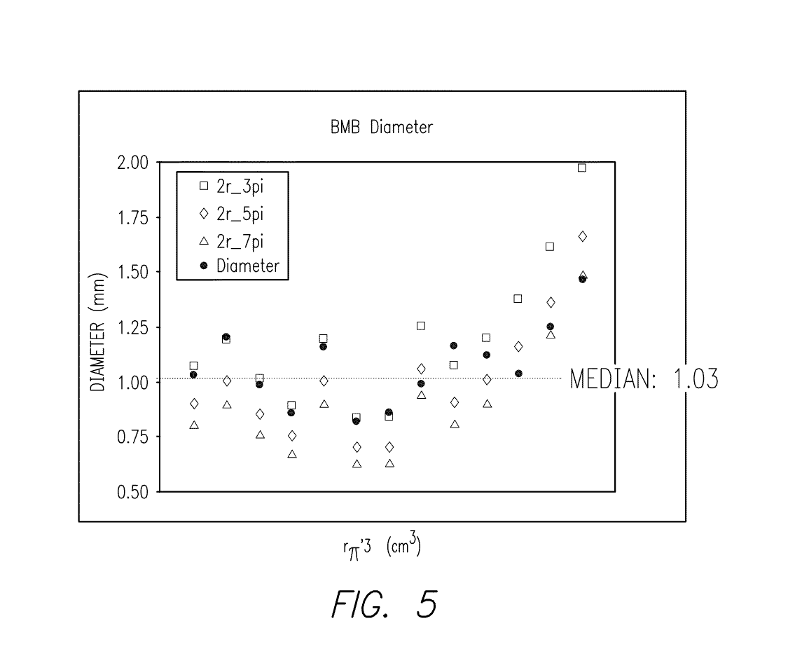

FIG. 5 is a graph showing Estimated BMB Lesion Diameter Values. Estimated BMB lesion diameters are shown bounded by phase diameter estimates (2r_{π}, 2r_{3π}, 2r_{5π}) for 13 samples. The lesion diameter estimates are based on diameter estimates of inner hyperintense rings in axial dipole phase patterns (FIGS. 3K and 3L). Phase diameters are calculated from corresponding r_{π} values. BMB estimated diameters ranged from 0.82 to 1.5 mm (median 1.0 mm). Diameter values ranged from 0.82 to 1.5 mm (median 1.0 mm).

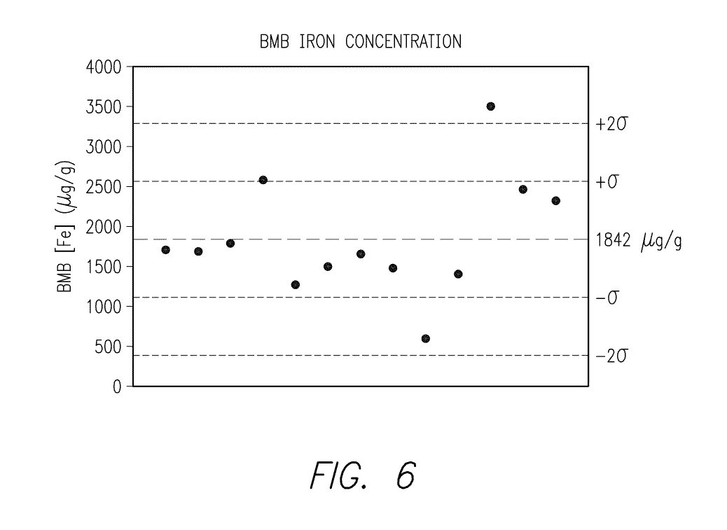

FIG. 6 is a scatter plot showing estimated BMB iron concentrations. The iron concentration values were normally distributed with a mean value of 1842 μg tissue. Ten of 13, and 12 of 13 samples fell within ±1, or ±2 standard deviations about the mean, respectively.

### Discussion

The present study demonstrates that parameters from phase images can be related to iron content in real BMB in postmortem tissue. As discussed below, FIG. 4 serves as at least a potential standard curve for human BMB where r′_{π} values of filtered phase images can be related to BMB iron mass. The strong linear correlation is predicted by Eq. 6 and validates the quantification method, where the spherical dipole model gives satisfactory results for our BMB samples. Iron sample mass resolution from our tissue samples was estimated to be 0.3 μg based on the statistically significant intercept (FIG. 4). In addition, we report estimates of BMB iron mass and concentration based on direct tissue iron measurements and phase image parameters. We used atomic absorption spectrometry (considered a gold standard for tissue metal concentration measurements) to determine lesion iron content that ranged from 0.065 to 13.1 μg with a median value of 1.0 μg. Lesion diameters were estimated using features of axial dipole phase patterns. The lesion iron concentration was found to be normally distributed with a mean value of 1842±202 μg/g (mean±standard error). Seventy-seven percent and 92% of the BMB sample iron concentrations fell within ±one and two standard deviations of the mean respectively. A normal distribution allows for a simple assessment of disparity between e.g., BMB concentrations in different brain regions or diseases.

BMB are associated with a growing number of disease states and present a source of potentially cytotoxic iron to the brain in proportion to the extent of blood extravasation. Therefore the quantified iron content of BMB is a potential valuable biomarker to monitor disease progression, treatment efficacy and risk factor assessments. In recent reports: the presence of a single lobar bleed, or more than one lobar bleed fulfill in part the Boston criteria for the diagnosis of possible and probable CAA respectively; two or more baseline BMB is associated with progression from MCI to outright dementia; BMB≧5 was associated with higher risk of ICH than benefit of anti-thrombotic agents. Such studies are examples where results and clinical implications are based on BMB number. However, measurement of iron content as a continuous variable goes beyond an assessment of pathologic severity based on presence/absence or a discrete number of bleeds. Our method of localized BMB (iron) quantification allows the characterization of severity at the level of a single bleed, groups of bleeds, brain region or whole brain. For example, indices of iron load or disease burden could be defined as e.g. “the sum of the iron content for all lobar BMB”. Such characterizations could provide advantages over diagnostic criteria, prognostic standards or therapeutic recommendations based on discrete numeric thresholds.

In efforts to improve interrater agreement in BMB detection and capture standardized auxiliary information several investigators have developed systematic BMB rating scales for reliable measures of presence, number, anatomical location, certain/uncertain status, and/or size. Results of the present study suggest that quantified iron content could enhance the usefulness of such discrete data We found a wide range of iron content (0.065-13.1 μg) for BMB with estimated diameters ranging from 0.82 to 1.5 mm. In addition, BMB with a diameter of 3.2 mm (unbloomed) and iron concentration of 2000 μg/g would contain ˜35 μg of iron. Therefore, since our mean concentration of 1842 μg/g is probably a lower bound value, in BMB that typically meet rating scale inclusion criteria, iron content may range over two orders of magnitude. This suggests that mere counts may not necessarily be i) a good indicator of bleeding severity (e.g., 5 BMB of 1 μg each versus 1 BMB with 15 μg), or ii) a sensitive means for patient and study group comparisons (e.g., “number of BMB in the parietal cortex” versus “total iron load of parietal cortex”) compared to iron content per se.

It is well known that BMB hypointensity size seen in magnitude GRE T2* images are typically larger than the actual tissue lesion. This so called blooming effect varies with field strength, scan parameters and magnetic susceptibility of the source. Results from the present study demonstrate that BMB diameter estimation unobscured by the blooming effect is possible in phase images. The Eqs. 4 and 8 further reveal that these determinations can in principle be effectively compared across various field strengths and echo times. With this new found ability, the benefits of size criteria should be revisited. Indeed, for definitions of iron load indices to be usefully compared between studies or clinical situations, BMB minimum and maximum size limits are necessary. Source dimension quantification in principle allows an objective definition of such inclusion limits.

Automated BMB detection can further improve interrater agreement, as well as increase clinical practicality. Results from the present studies underscore that the scale of such dipole templates can be related to iron content. Therefore, using appropriately scaled dipole templates (e.g., varying r′_{π} and r_{π} parameters) BMB can be, not only counted but simultaneously their iron content can be quantified. Moreover, BMB can also be classified by size using r_{π} based diameter estimates or definitions. As described above, estimates can be made by from diameters of circles or rectangles best fit to inner phase wrap rings in axial filtered phase images (FIGS. 3K and 3L). The corresponding phase diameters (as defined above) calculated from corresponding r_{π} values could provide upper and lower bound values to the diameter estimates. Alternately, diameter could be defined based purely on r_{π} values and used for classification. For example, lesion diameter can be defined as r_{5π} based on pertinent knowledge of source propertied. Finally, iron or disease load indices could then be calculated from count, location and severity (i.e., iron content) data, and clinically or biologically relevant threshold criteria could flag for further investigation, provide diagnostic information or therapeutic recommendations.

There are several limitations to the present study. First of all, while possessing several advantages over magnitude images for iron quantification, phase image approaches also face limitations. Phase contrast depends on source geometry and orientation with respect to the main magnetic field, and field perturbations extend beyond sources of susceptibility and alter contrast of surrounding tissue. These effects ultimately arise from fundamental physical properties of the magnetic field (e.g., solenoidality) and cannot be fully eliminated. However, unlike quantification of iron in distributed tissue regions (e.g., red nucleus), our localized method is not impacted by such effects and actually exploits them: The r_{π} and r_{′π} image parameters are related to magnetic field intensity on the directionally dependent dipole pattern outside the localized susceptibility source. Advantage is conferred by 1) providing additional dynamic range in pixilated images allowing resolution of very small sources that could not otherwise be resolved. This range can be increased by increasing echo time provided that the concomitant loss in SNR is not too large. 2) Since parameter measurements occur far away from the actual lesion, the shape of the source is less important. Under appropriate circumstances, this permits the assumption of a spherically symmetric source and greatly simplifies quantification and clinical practicality.

Secondly, we have assumed that BMB iron sources are effectively spheres. In most BMB, the actual geometry can likely be ignored because of far field effects. Indeed, this may be reflected in the definition of BMB as “round’ hypointense GRE T₂* (magnitude) image features by recently proposed BMB rating scale. However, other recommendations allow for “ovoid” hypointensities and it is expected that the spherical geometry assumption may not be globally applicable. However, based on at least three observations, non-spherical effects do not seem to be important in the present study: 1) The average ratio of the π-wrap bounding rectangle in the axial images was 0.99±0.08 suggesting circularity in the equatorial plane. 2) The r′_{π}/r_{π} ratio for the horizontal dipole patterns was consistent with the theoretical value for a spherical source. 3) Under the spherical assumption, the plot of m_{Fe} vs. r′_{π} was strongly linear (FIG. 6).

Thirdly, our method is a linear model based on the assumptions of uniform iron density and susceptibility. In the present study, the very good linear correlation between iron mass and r′_{π} seems to imply that these BMB have a relatively small variance. However, because our BMB represent a small number of cases and a specific disease population, it is not possible to draw conclusions about BMB in other disease states. Therefore, the plot of m_{Fe} vs. r′_{π} (FIG. 4) can only be regarded as a tentative standardization curve of iron content.

Fourth, because sample inclusion before data processing and sample exclusion after processing was based on dipole quality, our results are possibly biased toward best-case scenarios. However, our study analyzed BMB in postmortem tissue slices and in almost all cases, lesions were visible on the surface of the tissue. BMB dipoles in intact brain will not be influenced by issues and artifacts associated with lesion bisection and cut-tissue interfaces. Therefore, dipoles of comparable iron content could likely be better formed than those excluded in our study. In addition, faint excluded dipoles were associated with iron values at or below the sensitivity threshold of the method (˜0.3 μg), and thus do not actually contribute to a bias. Finally, background phase distortion is less of an issue in clinical scanners when compared to the experimental hardware used in the present study. In any case, whether in a clinical or experimental context, malformed and ambiguous phase image features are likely to be present. How often these cases occur and to what extent the method is affected must be informed by further research. Finally, in such cases, automated image processing software could still possibly discern essential features from dipole patterns that appear faint and indistinct to the human eye.

Finally, the present study was conducted in postmortem tissue with very small fields of view (2.2 cm) and at very high field 11.7T. Eq. 8 implies in principle that equivalent r_{π} and r′_{π} values are achievable even with the clinically state of the art 3.0T magnets. For example, at 3.0T an echo time of 27 ms is required to get dipoles with the same r_{π} values as this current study (Eq. 8), a value well within current use in BMB detection. However, practical issues concerning questions of adequate SNR and sufficiently short scan times have yet to be addressed with acquisitions using FOVs that are an order of magnitude larger than in the current study.

In summary, these post mortem results demonstrate that real BMB can be accurately related to prominent phase image parameters under the simple assumption that BMB iron sources are spherically shaped. Our m_{Fe} vs. r′_{π}³ plot can tentatively be regarded as a standard curve, allowing BMB iron content estimates in tissue states similar to our AD/CAA autopsy cases. In addition, phase image features were used to estimate upper bounds of BMB iron source diameters and lower bounds of iron concentrations. Our method potentially allows the definition of iron load or disease burden indices at the level of a single bleed, to the whole brain (e.g. “the sum of the iron content of all lobar BMB”), as well as the classification of BMB by size unobscured by the blooming effect. A “count, classify and quantify” method can potentially be fully or semi-automated, and results can in principle be compared across field strengths and echo times. Such information can enhance prognostic and diagnostic criteria in the context of cerebral vessel disease associated late onset dementias, as well as inform treatment decisions regarding the use of thrombolytic or thrombotic agents.

In the following study, we applied our methods to small hemorrhagic lesions induced in the in vivo rat brain using bacterial collagenase. As expected by theory, measurements of geometric features in phase images correlated with lesion iron content measured by graphite furnace atomic absorption spectrometry. Iron content estimation following BMB in vivo can shed light on the role and temporal evolution of iron-mediated tissue damage and the efficacy of potential treatments in cerebrovascular diseases associated with BMB.

### Animal Procedures

Our animal protocol was approved by the Loma Linda University Institutional Animal Care and Use Committee. Ten male Sprague-Dawley rats (450-500 g) were placed under anesthesia (isoflurane) and positioned in a stereotactic frame (Knopf Instruments, Tujunga, Calif.). A midline incision was made and the scalp was retracted. A small burr hole (˜1.5 mm) was drilled into the skull 0.5 mm anterior and 3.1±0.2 mm lateral from bregma. A single dose of type VII bacterial collagenase in saline (Sigma-Aldrich, St. Louis, Mo.) was injected 6.1 mm below the skull surface using a Hamilton syringe (Reno, Nev.) placed in a microsyringe pump (Model 310 Plus Series, KD Scientific, Holliston, Mass.) targeting the caudate/putamen (CP) of the rat brain. A range of collagenase doses (0.11 U/200 nl saline, 0.14 U/200 nl, 0.15 U/200 nl, 0.16 U/200 nl, 0.17 U/200 nl, 0.18 U/200 nl, 0.2 U/200 nl, 0.22 U/200 nl, 0.24 U/200 nl saline) were injected over 5 min. To minimize bleeding of injectate up the needle tract, the needle was held in place for 20 minutes following the injections and then slowly withdrawn at approximately 0.5 mm/min. The burr hole was filled with bone wax, the scalp sutured shut, and the rats were allowed to recover. One animal was euthanized on postoperative day (POD) 2 due to surgical complications and 9 rats underwent MR scanning.

### MR Imaging

Rats were scanned POD 28±2 in a 4.7T small animal MR scanner (Bruker Biospin, Billerica Mass.) using two SWI sequences with the following parameters: 1) 3D coronal SWI: TR/TE: 46.5/25 ms (TR/TE: 39/20 ms for two rats), flip angle: 17°, matrix: 256×256, NEX: 3, FOV: 3.0 cm, in-plane resolution: 117 μm×117 μm, and 32 slices of thickness 0.938 mm. 2) 2D axial SWI: TR/TE: 558.3/25 ms (TRITE: 1248.8/20 ms for two rats), flip angle: 20°, matrix: 256×256, NEX: 6, FOV: 3.0 cm, in-plane resolution: 117 μm×117 μm, slices: 10, 12 or 32 of thickness 0.8 mm.

### Lesion Dissection

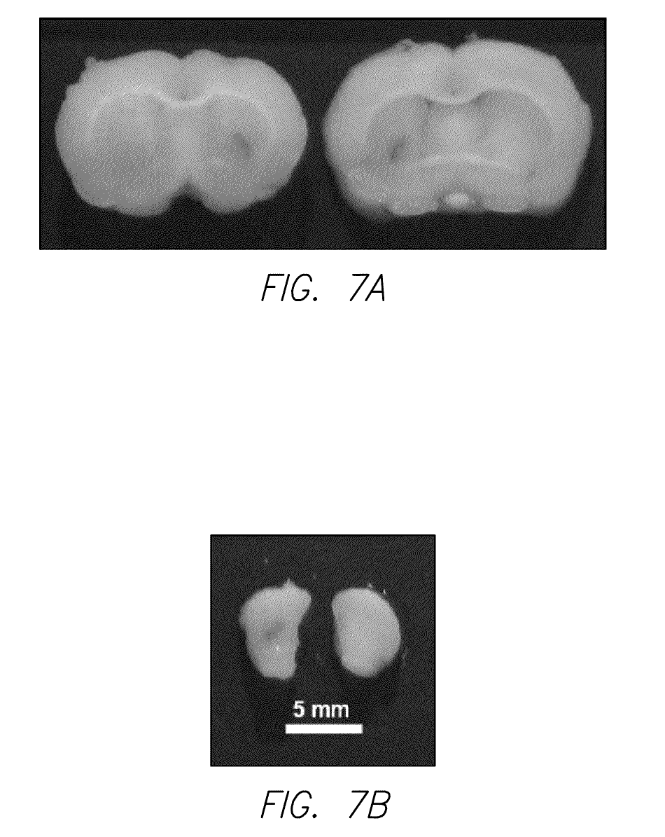

Immediately following MR scanning, animals were sacrificed by exsanguination by way of transcardial perfusion with 4% buffered paraformaldehyde (PFA). Brains were extracted from the skull and fixed in 4% PFA. The rat brains were sectioned coronally anterior and posterior to the needle tract that was visible at the top of the brain. Additional dissection was performed as necessary to reveal the anterior/posterior lesion boundaries and trim away excess tissue. Sections of tissue surrounding the lesion (ipsilateral CP) and control sections (contralateral CP) were dissected out of the coronal slices using a diamond knife and nylon and titanium forceps (FIG. 7) and weighed on a precision balance.

FIG. 7A shows two successive coronal sections of a rat brain with a collagenase-induced bleed in the right CP. FIG. 7B shows dissected tissue surrounding the bleed taken from the right CP, and a control tissue sample taken from the left CP.

### Iron Content Determination

Samples were wet ashed: blocks (20-70 mg) were dissolved in 250 μl of 70% HNO₃ overnight, heated at 80° C. for 20 min, and allowed to cool to room temperature. 250 μl of 10M of H₂O₂ were added and, after 30 min, samples were heated to 70° C. for 15 min and allowed to cool. Iron concentrations were measured in triplicate by graphite furnace atomic absorption spectrometry (GF-AAS) (SpectrAA 220Z, Varian, Victoria, Australia). Assuming that contra- and ipsilateral CP have comparable background iron concentrations, lesion iron content was calculated using the formula: m_{(Fe)L}=f_{(Fe)I}M_{I}−f_{(Fe)C}M_{I}, where m_{(Fe)L} is the mass of iron in the lesion, f_{(Fe)I} (f_{(Fe)C}) is the w/w Fe concentration of the ipsilateral (contralateral) tissue block, and m₁ is the mass of ipsilateral tissue.

### Image Processing

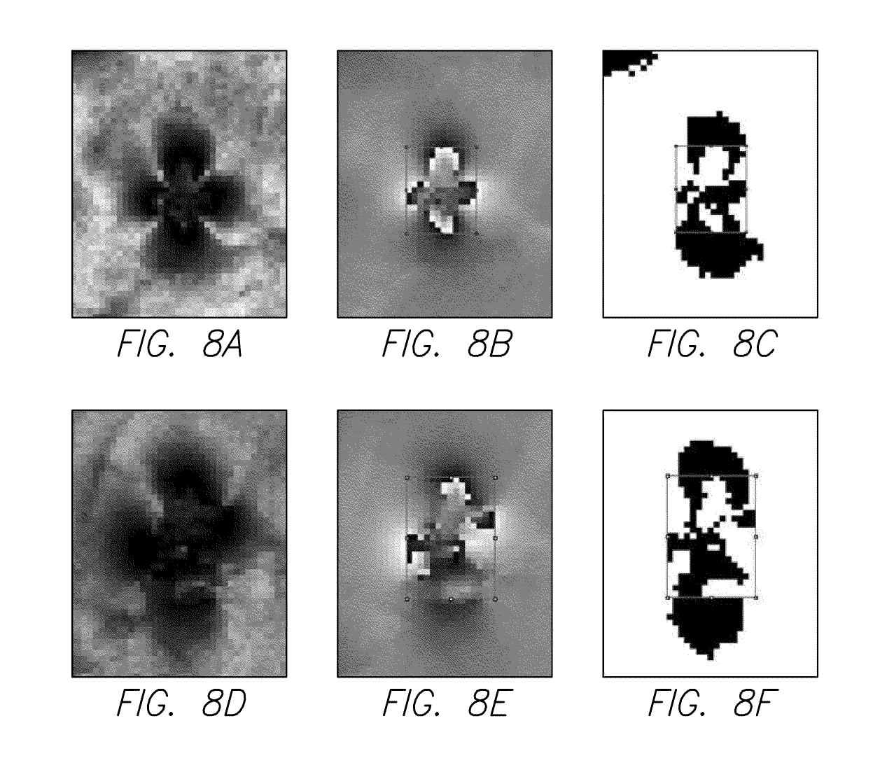

3D (2D) raw phase images were high-pass filtered using a 16×32 (32×32) frequency domain filter (39) using SPIN software (SPIN software, MRI Institute, Detroit, Mich.). Magnitude images were multiplied four times by the product of the negative and positive phase mask of reference. The image parameter r′_{π} was obtained using the vertical dimension of rectangles bounding the coronal phase dipole patterns in the 3D images. However, all gray-scale images were converted to binary images using ImageJ software (NIH) before bounding rectangles were drawn allowing a more objective determination of r′_{π} in one case where the location of the vertical phase wrap was ambiguous (see FIG. 8). Still, a slight ambiguity remained for Case 3 (reflected in the larger uncertainty for r_{π}′ in Table 2 (see Appendix A)). Measured r′_{π} values from images acquired with T_{E}=20 ms were scaled by a factor of 1.08 in accordance with Eq. 8 of (38). (Note that 2D images are used for lesion visualization only (FIG. 8))

FIGS. 8A-8F show the assignment of bounding rectangles in binary images of in vivo rat brain. All high pass filtered phase (HP) images were converted to binary images before bounding rectangles were drawn allowing a more objective determination of r′_{π} for one sample. FIGS. 8A and 8D are phase enhanced magnitude images, FIGS. 8B and 8E are HP images, FIGS. 8C and 8F are binary conversions of FIGS. 8B and 8E from two different cases. In FIGS. 8A and 8B the dipole phase wraps are well defined, whereas the bottom vertical phase wrap in FIG. 8E is indistinct. However, the binary images (FIGS. 8C and 8F), show distinct black/white phase wraps for both samples. The rectangles defined in binary images FIGS. 8C and 8F are shown superimposed on the HP images in FIGS. 8B and 8E.

### Statistical Analysis

The relationship predicted by Eq. 6 between BMB iron mass and r′_{π} was tested by linear regression analysis using SigmaPlot version 11 (Systat Software, Inc., Chicago, Ill.). A plot of (m_{Fe})^{1/3} vs. r′_{π} was constructed along with a best-fit least squares regression line. Statistical significance was considered at p<0.05. Finally, we note that the independent variable in the regression model is measured with uncertainty. In general, uncertainty in a predictor variable leads to bias in the regression parameters. However, in the present study the slope and intercept are free from bias, and coefficient of determination (R²) is attenuated by <4% (see Appendix B). We report the attenuated value.

### Error Analysis

Uncertainties in the plotted variables (m_{Fe})^{1/3} and r′_{π} are given by Eqs. 9-13 (see Appendix A for more details):

δr_{π}′=(s²δn₊²+δn₋²+t²/36²)^{1/2}

δr_{π}′ is the uncertainty in r_{π}′, s is the in-plane voxel dimension parallel to B₀, t is the slice thickness, and δn+ and δn− are respectively the uncertainty in number of voxels of the upper and lower edges of the bounding rectangle.

$$\begin{matrix} δ ( {m}_{Fe}^{1 / 3} ) = \frac{δ {m}_{Fe}}{3 {m}_{Fe}^{2 / 3}} & [ 10 ] \\ δ {m}_{Fe} = {( {( δ {m}_{I} )}^{2} {( {f}_{( Fe ) I} - {f}_{( Fe ) C} )}^{2} + {m}_{I}^{2} ( {( δ {f}_{( Fe ) I} )}^{2} + {( δ {f}_{( Fe ) C} )}^{2} ) )}^{1 / 2} & [ 11 ] \\ δ {f}_{( Fe ) I} = ( \frac{α}{{m}_{I}} ) {( {( {m}_{I} + {m}_{s} )}^{2} {( {STE}_{{f}_{( Fe ) I}} )}^{2} + {( 0.5 {f}_{( Fe ) I} )}^{2} + {( δ {m}_{I} )}^{2} )}^{1 / 2} & [ 12 ] \\ δ {f}_{( Fe ) C} = ( \frac{α}{{m}_{C}} ) {( {( {m}_{C} + {m}_{s} )}^{2} {( {STE}_{{f}_{( Fe ) C}} )}^{2} + {( 0.5 {f}_{( Fe ) C} )}^{2} + {( δ {m}_{C} )}^{2} )}^{1 / 2} & [ 513\end{matrix}$$

δ(m_{Fe}^{1/3}) and δm_{Fe} are the uncertainty in m_{Fe}^{1/3} and m_{Fe} respectively, α is a dilution factor and mₛ is the mass of HNO₃ solution (both required in the GF-AAS iron assay), STE stands for standard error, δm₁ and δm_{C} are respectively the uncertainty in ipsilateral and contralateral tissue block mass, and all other variables are as defined in the Iron Content Determination section above.

The uncertainty in the predicted iron mass, δ\hat{m}_{F}_{ₑ}, given by Eq. 14 below, is a different kind of uncertainty that can be used to assess how measurement errors in r_{π}′ affect how well the linear model compares with the experimental data (see Appendix A):

$$δ {\hat{m}}_{{F}_{e}} = ( \frac{6 {π}^{2} ρ}{γ Δ χ {B}_{0} {T}_{E}} ) {r}_{π}^{′2} δ {r}_{π}^{′} \qquad [ 14 ]$$

### Results

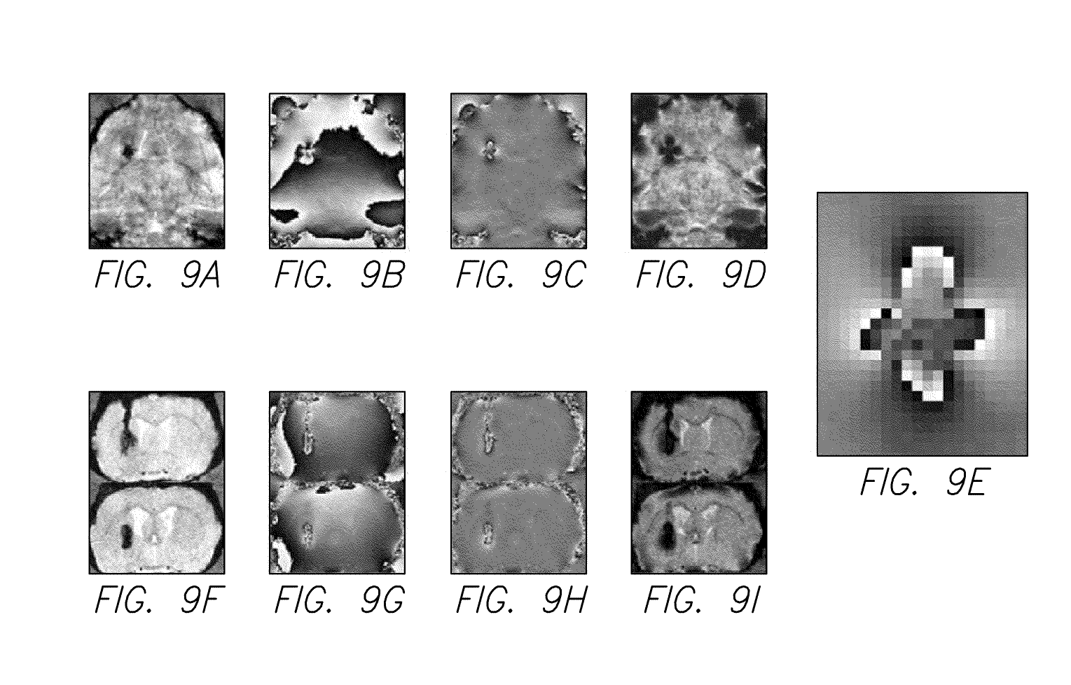

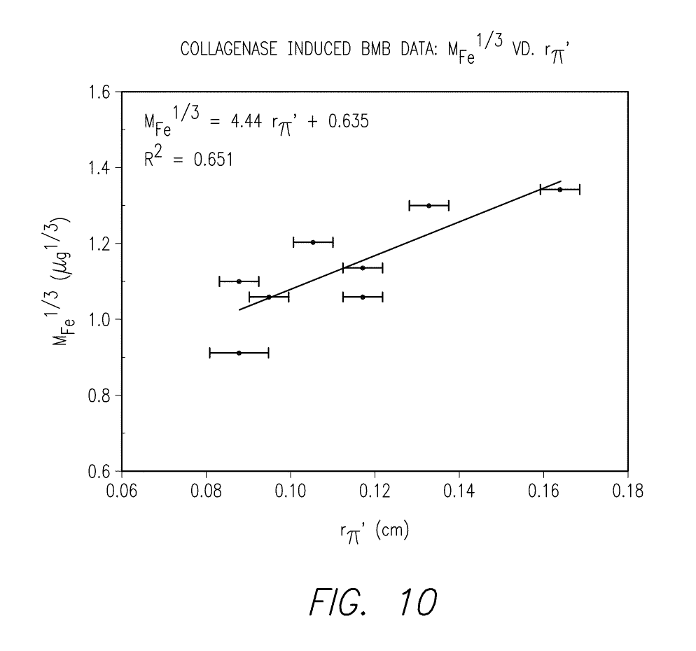

Consistent with right CP lesions, right circling behavior, left forelimb paresis, and loss of left whisker reflex was observed in rats in varying degree and duration following surgery. MR images confirmed the presence of these lesions in the CP (FIGS. 9A-9I). Dipole patterns were observed in SWI phase, filtered phase, phase mask, phase-enhanced magnitude, and to a lesser extent, magnitude images. However, when compared to our previous focal quantification studies, the dipole patterns were generally not as distinct nor as symmetric. The lesions were generally more spatially distributed and not spherical, typically elongated in a dorsal-ventral (e.g., see FIG. 7 and FIGS. 9F-9I) and rostral-caudal orientations. One rat was excluded because the lesion dipole pattern was distorted by background phase and image data from 8 animals were analyzed. Iron mass and image parameter data for these animals are shown in Table 2. The median iron mass of the induced BMB was 1.40 μg.

TABLE 2
Collagenase-Induced BMB Image Data

| Subject | m_{Fe} (μg) | (m_{Fe})^{1/3} (μg^{1/3}) | r′_{π} (mm) |
|---|---|---|---|
| 1 | 1.19 ± 0.02 | 1.06 ± 0.01 | 0.95 ± 0.05 |
| 2 | 2.19 ± 0.04 | 1.30 ± 0.01 | 1.33 ± 0.05 |
| 3 | 0.76 ± 0.02 | 0.91 ± 0.01 | 0.88 ± 0.07 |
| 4 | 1.33 ± 0.06 | 1.10 ± 0.02 | 0.88 ± 0.05 |
| 5 | 1.47 ± 0.03 | 1.14 ± 0.01 | 1.17 ± 0.05 |
| 6 | 1.19 ± 0.03 | 1.06 ± 0.01 | 1.17 ± 0.05 |
| 7 | 1.74 ± 0.03 | 1.20 ± 0.01 | 1.06 ± 0.05 |
| 8 | 2.41 ± 0.03 | 1.34 ± 0.01 | 1.64 ± 0.05 |

Data is shown for collagenase-induced lesions in the CP of the rat brain.
Iron mass (mFe) was measured using atomic absorption spectrometry.
r′_{π} data was obtained from the vertical dimension (i.e., parallel to B0) of rectangles bounding the coronal dipole phase pattern in binary images.
Uncertainties were calculated using Eqs. 9-13, A1 and A2 as described in the text and Appendix A.

FIGS. 9A-9I show: in vivo axial and coronal SWI scans of collagenase induced BMB. In vivo magnitude (FIGS. 9A and 9F), raw phase (FIGS. 9B and 9G), high pass-filtered (FIGS. 9C and 9H), phase-enhanced magnitude (FIGS. 9D and 9I) SWI images in coronal (FIGS. 9A-9D) and axial orientations (FIGS. 9F-9I) of a BMB induced in the caudate/putamen of the living rat brain (subject 1, Table 2) (two successive slices are shown for axial images). FIG. 9E shows a magnification of the dipole pattern in FIG. 9C. Note the dorsal/ventral elongation of the bleeds in the axial images.

FIG. 10 shows a graph where the cube root of iron mass from collagenase-induced BMB is plotted against r′_{π}. The plot of m_{Fe}^{1/3} vs. r′_{π} revealed a statistically significant linear relationship (attenuated R²=0.65, p=0.012) as was expected based on the theory underlying the quantification method. The slope was found to be 4.4 μg^{1/3}/cm (p=0.012) and the intercept, while predicted to vanish, was statistically different from zero (0.64 μg^{1/3}, p=0.005). The effective mass magnetic susceptibility (Δχ/ρ) of the sample legions was calculated from the slope and found to be 7.2×10⁻⁶ m³/kg, about 5 times larger than reports for human liver ferritin and hemosiderin and about 9 times larger than reported in our postmortem human study. Finally, using the slope of FIG. 10, δ\hat{m}_{F}_{ₑ} of Eq. 5 was found to range from 0.01 to 0.04 μg, with a mean of 0.02 μg, a standard deviation of 0.01 μg, and a median of 0.02 μg.

### Discussion

In the present work, we tested our focal iron quantification technique in a simple collagenase-induced BMB model in the living rat brain. The BMB dimensions were on the order of 1-2.5 millimeters in size and contained 0.8 to 2.4 μg of iron. Thus, the size and iron content of the BMB were relevant to human BMB. Dipole patterns were present in experimentally induced bleeds and were measured for the r′_{π} parameter. A plot of the cube root of lesion iron mass against r′_{π} produced a linear graph as expected by the theory underlying the quantification technique. This can be thought of as a standard curve whereby other BMB could be assayed for iron content in the rat brain.

However, the dipole patterns associated with collagenase hemorrhages were not as distinct as previously observed from BMB in postmortem human brain, nor was the linear correlation relating iron mass and r′_{π} as strong (r=0.81 (attenuated) vs. r=0.99). This is most likely due to less focal bleeding in the present study (FIG. 1 and FIGS. 3F-3I). While an established ICH rat model typically delivers 0.2 U of collagenase in 1 μl of saline, the smaller doses and volumes used in the present study reflect an attempt to induce smaller and more focal hemorrhagic legions to better model BMB. However, it appears the collagenase injections caused more spatially diffuse bleeding than is characteristic of real BMB which generally originate from a single ruptured vessel. Refinements to the BMB induction technique leading to more concentrated lesions and distinct dipoles are possible. For example, diffusion of collagenase through the brain tissue likely contributes to the non-locality including dorsal/ventral and rostral/caudal elongation of the induced lesions. The use of a glass micro needle (which have outer diameters an order of magnitude smaller than the 26 gauge needle used here) and the associated smaller bore needle tract could lead to less diffusion of enzyme away from the injection site and thus more localized bleeding and iron deposition. On the other hand, an alternate model that uses ultrashort laser pulses to induce hemorrhages in targeted single microvessels may offer superior results compared to a collagenase induced BMB model at least for cortical bleeds.

Critical to the validation of the quantification technique is the correlation between BMB iron measured by GF-AAS and the phase image parameter r_{π}′. In the living rat brain, lesion susceptibility varies as red cell breakdown, heme degradation and hemosiderin formation evolves. Similarly, in this experiment, the amount of paramagnetic iron detectible by (or “visible” to) the MR scanner is also expected to vary with lesion age. Therefore since GF-AAS always measures the total iron present in the tissue, perfect correlations can only occur if the imaging is done when all the iron extravasated following the BMB is visible. In humans, hematoidin, a marker of free iron release due to hemeoxygenase activity, peaks around POD 10 and hemosiderin deposition peaks around POD 10-14. We chose POD 28 to image and sacrifice the rats assuming that hemosiderin formation would be essentially complete. However, one possible explanation for the unexpected non-zero intercept in the plot of FIG. 10 is the presence of non-MR visible iron. A longitudinal study design with 1) multiple time point extending beyond POD 28, and 2) with an additional component investigating the magnetic and biochemical properties of lesion iron and associated molecules in the tissue, could shed further light on how lesion iron accumulation, concentration, magnetic properties and MR-visibility vary over time.

The non-zero intercept in FIG. 10 suggests that not all iron is accounted for by r_{π}′ measurements. Examination of Table 2 and FIG. 10 reveals that the mass of iron associated with point pairs with similar or equal r′_{π} values differ by ˜0.3-0.6 μg. This suggests that the sensitivity of the technique at this image resolution may also contribute to the non-zero intercept. However, the largest uncertainty of predicted iron mass (m_{Fe hat}) for our 8 cases was found to be ˜0.04 μg, over six times smaller than that implied by intercept of 0.64 μg^{1/3}. Therefore, discreet voxel size alone may not explain the discrepancy. Besides a contribution from non-visible iron discussed above, an alternate possibility is that the single parameter only approximates the iron content of non-spherical lesions. Finally, another point of interest consequent from FIG. 10 is the difference in lesion mass susceptibility compared with human liver hemosiderin and our postmortem study. Whether this results from differences in species, bleeding mode, artifacts of fixation on tissue and lesion susceptibility, or other factors is an important question that calls for further study.

In conclusion, we have shown that an SWI phase image method can be used to estimate focal iron content on the order of a few micrograms in the living rodent brain using simple modifications of an established collagenase ICH model. Improvements to the experimental technique or the use of alternate bleeding models are expected to produce superior results and could further increase the usefulness of the technique in animal models. This will allow investigation of the temporal progression of bleeding lesions and the role of iron-mediated tissue damage and the efficacy of therapeutic interventions in small cerebral vessel disease associated with BMB.

### Method Description

In one embodiment of the present invention, a semi-automated software method is provided for the quantification of localized iron sources in brain microbleeds (BMB) using magnetic resonance phase images. The iron sources are considered to be spherical iron deposits in the BMB. By “quantification of . . . iron” we mean i) quantification of the mass of iron in the BMB, and ii) quantification of the “true” (i.e., apart for the blooming effect) effective iron source diameter.

The quantification and analysis software system consists of the modules below. As per common software engineering practice, these modules can be implemented in object oriented code as base classes from which more specialized variations of the modules can be derived (thus, while we use the term ‘modules’ for simplicity, ‘family of modules’ is a better description). The modules are organized into a “pipeline” framework that sequentially processes the modules (in the order of there appearance below: Steps 1 through 8). However, only Steps 1, 2, 4 and 5 are required for a processing run and the remaining modules are optional. Finally, we note that the object-oriented framework design allows the system to be easily extended so that new functionality can be added as is deemed useful for specific applications of the method. We therefore discuss the function or features of each module in general terms and then offer specific examples of functionality. The modules are as follows:

### 1. Parameter Module

This module contains values for various parameters used to process all modules in the pipeline. The most important set of parameters are the equation coefficients used to calculate iron mass based on image measurements. These are the coefficients in equation 6 described above. These coefficients can be obtained using standard curves of BMB iron vs. phase image parameters as described above. Other parameters, for example, specify which specific calculation and analysis modules to use in process run. The user selects the parameters at the beginning of processing from a graphical user interface (GUI).

### 2. Image Input and Filtering

A standard image library (e.g., ITK) is used to read a processed MR phase image stack into the pipeline framework. The image stack can be processed as i) a set of two dimensional (2D) images, or ii) merged into a single three dimensional (3D) volume. If the images do not contain isotropic voxels, interpolation using standard methods must be performed for case ii.

### 3. Image Filtering

Various filters can be applied to the image data before the pattern identification step. For example, an ‘image layer’ identifying anatomical brain regions can be imported to or drawn on an image stack.

### 4. Pattern Identification

Dipole pattern identification is accomplished using variations of the 2D (case i, Step 2) or 3D (case ii, Step 2) PDQ (Phase map cross-correlation Detection and Quantification) method described by Mills et al. (Mills P H, Wu Y-J L, Ho C, Ahrens E T. Sensitive and automated detection of iron-oxide-labeled cells using phase image cross-correlation analysis. Magnetic Resonance Imaging 2008; 26(5):618-628.), which is incorporated herein by reference in its entirety. In this method the distinct dipole ‘burger’ shape is used as a template and systematically overlaid onto every template-sized area of the phase image (see e.g., FIGS. 1 and 3 above for examples of dipole patterns in modeled or real BMB, and FIG. 2 of the Mills et al. reference for examples of 2D and 3D templates used by the PDQ method). The similarity between the template and image patch is given a score based on a cross-correlation formula. An essential variation of the method for our application is instead of a single template, multiple templates, each scaled according to r_{π}′ are passed over the image and scored. Because the right-sized template will have the highest score, an image feature (i.e., a putative dipole pattern) is matched based not only on mere presence of a dipole, but also on iron content. A second variation is the use of circular template for axial oriented images. The radius of this template is scaled by various parameters: d*, r_{π}, r_{3π}, r_{5π}, etc., that can be used to estimate the value or range of the effective iron source diameter (unobscured by the ‘blooming effect’). The degree of matching is scored using a numerical scale where zero represents no correlation to a particular template and 100 is a perfect match—that is the image feature and the dipole template are identical. Score threshold values are used to decide if the image feature is identified as a dipole pattern within an acceptable tolerance. In a borderline case, the feature is determined a ‘possible’ dipole pattern and is flagged for manual inspection. For example, a score of 80 or greater could be considered a dipole and a score between 50 and 55 a possible dipole. Once a feature is identified as a dipole, a record is created in a database that stores information about the feature.

### 5. Pattern Quantification

The scale of such dipole templates (e.g., quantified by r_{π}′, d*, or bounded by r_{3π}, etc.) can be related to iron content and effective iron source diameter as described above. In the Pattern Identification module each of the dipole pattern templates is associated with the proper r_{π}′ and/or d*, etc. In this Pattern Quantification module, an image feature is assigned an iron content level, effective diameter, upper-bound diameter, and/or diameter range (depending on the application), based on the template that best matches the image feature. In other words, e.g. the r_{π}′ value from the template with the largest score is assigned to the image feature and then the iron content is calculated based on r_{π}′ using equations and parameters in the Parameters module. Relevant quantification information is added to the database for the image feature.

### 6. Object Classification

After image features are automatically identified and quantified, object classification proceeds on two levels: 1) Automated classifications are done based on what the system ‘knows’ about the identified features: what is in the database and Parameters module data structures, and what is communicated through instantiated objects of specific Object Classification classes. For example, if anatomical regions are mapped to an image stack through an Image Filter object (as described in Step 3 above), an Object Classification instance can be used to automatically classify identified image features by e.g., brain lobe or nucleus. 2) Information can also be supplied by the user. For example, following Step 5 the image stack, marked with each identified feature, can be presented to the user. The user can then manually associate the feature with any number of tags. For example, a location tag such as “Parietal Lobe” can be associated with feature identified in the parietal lobe of the brain. All tags and automatic classifications are stored in the database.

### 7. Calculations and Analysis

This family of modules is used to perform calculations and analysis using information stored in the database. For example, the system can be queried to add the total iron content of all BMB in the parietal lobe, or calculate the average diameter of all the BMB in posterior brain regions. Similar information could potentially be valuable if it can be shown to be biologically or clinically relevant. Such queries can be initiated automatically in the pipeline, or manually from the GUI at the end of processing.

### 8. Decision/Interpretation

Based on output from the Calculations and Analysis modules various conditional criteria can be used to output a decision, interpretation or conclusion. For example, if the total iron content in a certain brain location falls between two particular threshold values, an output string of “Moderate lion Extravasation” could be assigned and displayed in the GUI. Alternately, an event could be triggered that would send an email alert informing medical staff of a condition that requires further attention. Ultimately, if validated by future clinical research, one could hope that tentative diagnostic information or therapeutic guidelines could be suggested by a future implementation of this module.

### Extension to Other Magnetic Materials and Other Application Areas

The present invention has been discussed in considerable detail with reference to certain preferred embodiments, other embodiments are possible. For example, we have described the semi-automated method in the specific context of quantifying iron content and effective iron source diameter in phase images of BMB. However, more generally, the same method can be used for other localized sources of magnetic susceptibility, in other image types, and in different problem domains. What is essential is a dipole pattern that represents a magnetic field induced in a material by an external magnetic field. Therefore, localized sources of paramagnetic or diamagnetic material may similarly be quantified in other medical or industrial applications. Accordingly, the scope of the appended claims should not be limited to the description of preferred embodiments contained in this disclosure. All references cited herein are incorporated by reference in their entirety.

### APPENDIX A

First order uncertainties were determined using standard techniques.

δr_{π}′=((sδn)²+t²/36²)^{1/2} [A1]

δn=(δn₊²+δn₋²)^{1/2} [A2]

δ(r_{π}′)³=3(r_{π}′)²δr_{π}′ [A3]

The uncertainties in r_{π}′ and r_{π}′³ (δr_{π}′ and δr_{π}′³ respectively) due the discreet nature of the voxels are given by Eqs. A1-A3. All variables have previously been defined in the text, except δn, the uncertainty in the number of voxels in the bounding rectangle in the direction parallel to B₀. The second term in Eq. A2 involves the slice thickness t. δn₊=δn₋ was taken to be 0.5, except for one case where the lower phase wrap was slightly ambiguous and δn₋ was taken as 1.0. Eq. 9 follows from Eqs. A1-A2. The uncertainly in lesion iron mass (δm_{Fe} and δm_{Fe}^{1/3}) was previously expressed by Eqs. 10-13 in the text. δm₁ and δm_{C} in these equations is related to the precision of the mass balance used to determine tissue block mass.

The above uncertainties are associated with the measured and plotted variables in this experiment. The uncertainty in the predicted iron mass due to measurement error in r_{π}′ expressed by Eq. 6 and Eq. A3.

Finally, we note that uncertainty in r_{π}′ due white noise was generally an order of magnitude lower than that due to discrete voxel size in this study and was thus neglected.

### APPENDIX B

Due to the finite voxel size in our experiment, the true r_{π}′ (which we denote as r_{π}′*) is unknown and we perform the regression using a surrogate variable—i.e., r_{π}′. These variables are related by Eq. A4:

r_{π}′*=r_{π}′±δr_{π}′* [A4]

where δr_{π}′* is the estimated uncertainty in the unobserved variable. δr_{π}′* is due to the finite voxel size and is independent of r_{π}′ measurements, therefore Eq. A4 represents an unbiased Berkson error model. In such a model the regression coefficients are not biased, but there is an increase in the residual variance, given by Eq. A5, and a corresponding decrease in R² seen in Eq. A6 (41,51):

$$\begin{matrix}{{σ}_{∈}^{2} \to {σ}_{∈}^{2} + {β}^{2} ( δ {r}_{π}^{′} *)}^{2} & [ A5 ] \\ {R}^{2} \to {R}^{2} - \frac{{{β}^{2} ( δ {r}_{π}^{′} *)}^{2}}{{σ}_{{m}^{1 / 3}}^{2}} & [ A6 ]\end{matrix}$$

Here σ_{ε}² and σ_{m1/3}² are the residual and total variance respectively, β is model coefficient, and the second terms in Eqs. A4 and A6 represent the increase and decrease due to error of the residual variance and regression coefficient (R²), respectively. For the present study, the last term of Eq. A6≈(4.4²)(0.005²)/(0.0195)=0.025. This represents a <4% decrease in from the naïve R²=0.68 to 0.65 (the attenuated R²). We thus conclude that in the present study the slope and intercept are free from bias and the effect of error on the regression coefficient is small. Finally, we note that the attenuation depends on the square of δr_{π}′*. Thus, decreased in-plane resolution and slice thicknesses result in smaller attenuations (e.g., δr_{π}′*→(0.5)(δr_{π}′*) leads to an attenuation of 0.01 or <2% in the present case.

What is claimed is:

1. A method to quantify iron content or effective diameter of a localized iron source in an anatomical region of a subject, comprising:
(a) obtaining a phase image from a magnetic resonance scan of the anatomical region of the subject;
(b) identifying a dipole pattern in the phase image corresponding to a localized iron source in the anatomical region;
(c) measuring one or more than one image parameter of the dipole pattern; and
(d) relating the image parameter measured in step (c) to a quantity of the iron contained in the localized iron source or the effective diameter of the source.

2. The method of claim 1, wherein the phase image is obtained from an in vivo magnetic resonance scan.

3. The method of claim 1, wherein the phase image is a raw phase image, a high-pass filtered phase image or a phase-enhanced magnitude image.

4. The method of claim 1, wherein the anatomical region comprises a portion of a brain.

5. The method of claim 4, wherein the localized iron source corresponds to a brain microbleed.

6. The method of claim 1, wherein the subject is a mammal.

7. The method of claim 1, wherein the subject is a human.

8. The method of claim 1, wherein the dipole pattern is in a horizontal, coronal or axial orientation.

9. The method of claim 1, wherein the dipole pattern is identified using one or more than one matching template.

10. The method of claim 1, wherein the image parameters r_{π} and r′_{π} are determined from a rectangle bounding the dipole pattern, the rectangle comprising a width and a height, where r_{π} is one half of the width and r′_{π} is one half of the height of the bounding rectangle.

11. The method of claim 10, further comprising converting gray-scale high pass filtered phase images to binary images before drawing bounding rectangles.

12. The method of claim 1, wherein the image parameter is related to the mass of iron, the iron concentration or the diameter of the localized iron source.

13. The method of claim 1, further comprising characterizing disease severity based on the quantity of iron determined in step (d).

14. The method of claim 13, further comprising repeating steps (a), (b), (c) and (d) at a later time point to monitor any change in disease severity.
